(19) United States
(12) Patent Application Publication
(10) Pub. No.: US 2019/0303377 A1
(43) Pub. Date: Oct. 3, 2019

(54) SUBSTANCE DETECTION METHOD AND APPARATUS, ELECTRONIC DEVICE, AND COMPUTER READABLE STORAGE MEDIUM

(71) Applicant: CLOUDMINDS (SHENZHEN) HOLDINGS CO., LTD., Shenzhen (CN)

(72) Inventors: Lei LUO, Shenzhen (CN); Taotao MU, Shenzhen (CN)

(21) Appl. No.: 16/397,461

(22) Filed: Apr. 29, 2019

Related U.S. Application Data
(63) Continuation of application No. PCT/CN2018/081089, filed on Mar. 29, 2018.

(51) Int. Cl. G06F 16/2457; G01N 21/25; G01N 21/84; G06F 16/2455

(52) U.S. Cl. CPC G06F 16/24578; G01N 21/25; G01N 2021/8405; G06F 16/24558; G01N 21/84

(57) ABSTRACT

A substance detection method, apparatus, and computer readable storage medium are provided. The method includes determining a substance having the highest matching degree with a spectrum of a to-be-detected substance in a database, wherein corresponding items of the substance in the database at least include a detachable attribute for marking whether the substance is a mixture. If it is determined that the substance is a mixture according to the detachable attribute in the corresponding items of the substance having the highest matching degree, mixture component information of the substance is obtained and displayed. The detachable attribute in the corresponding items of the substance is stored in the database to mark whether the substance is the mixture, so that whether the substance is the mixture can be queried from the database, and after the substance is determined as the mixture, the mixture component information of the to-be-detected substance is further provided.

### CROSS-REFERENCE TO RELATED APPLICATIONS

This application is a continuation of PCT application No. PCT/CN2018/081089 filed on Mar. 29, 2018, the contents of which are incorporated herein by reference.

### TECHNICAL FIELD

The present application relates to detection technical field, and in particular, to a substance detection method and apparatus, an electronic device, and a computer readable storage medium.

### BACKGROUND

An existing detection device may be generally used for directly analyzing the name of a substance or an item. For example, an infrared spectrometer detects chemicals such as potassium nitrate through an infrared transmission spectrum of the substance; and for example, a Raman spectrometer detects drugs such as cocaine through a scattering Raman spectrum and the like. However, all existing detection methods need to input spectrum data and substance names into databases in advance, and then, during the detection, match in the databases according to the collected spectra, and display the substance names with similarity exceeding setting thresholds to users as the identified results of the present detection.

### Technical Problem

In the process of implementing the present application, the inventors have found that, for a mixture denominated with a name, a user cannot obtain the specific composition of the substance by spectrum detection. For the cold cure New Contec, for example, generally a tablet is directly scanned during input, and the corresponding spectrum is directly named as the New Contec. In fact, the composition of each tablet of New Contec includes: acetaminophen 500 mg, dextromethorphan hydrobromide 15 mg, pseudoephedrine hydrochloride 30 mg and chlorpheniramine maleate 2 mg, and may also contain starch, magnesium stearate and other adjuvants. Even if these components have been completely or partially preserved in the database, they cannot be obtained by spectrum analysis, because the spectrum used in the detection is necessarily the most similar to the spectrum of the previously input “New Contec” spectrum. Therefore, the existing method of merely detecting the common name of the mixture may not meet the actual needs of the user.

### Technical Solution

A technical problem to be solved by a part of embodiments of the present application is to provide a substance detection method and apparatus, an electronic device, and a computer readable storage medium, in order to solve the above technical problem.

An embodiment of the present application provides a substance detection method, including: determining a substance having the highest matching degree with a spectrum of a to-be-detected substance in a database, wherein corresponding items of the substance in the database at least include a detachable attribute for marking whether the substance is a mixture; if it is determined that the to-be-detected substance is a mixture according to the detachable attribute in the corresponding items of the substance having the highest matching degree, obtaining mixture component information of the to-be-detected substance; and displaying the mixture component information of the to-be-detected substance.

The embodiment of the present application further provides a substance detection apparatus, including: a determining module, configured to determine a substance having the highest matching degree with a spectrum of a to-be-detected substance in a database, wherein corresponding items of the substance in the database at least include a detachable attribute for marking whether the substance is a mixture; an obtaining module configured to, if it is determined that the to-be-detected substance is a mixture according to the detachable attribute in the corresponding items of the substance having the highest matching degree, obtain mixture component information of the to-be-detected substance; and a display module, configured to display the mixture component information of the to-be-detected substance.

The embodiment of the present application further provides an electronic device, including: at least one processor; and a memory in communication connection with the at least one processor; wherein the memory stores instructions executable by the at least one processor, and the instructions are executed by the at least one processor to enable the at least one processor to execute the substance detection method involved in any method embodiments of the present application.

The embodiment of the present application further provides a computer readable storage medium storing computer instructions, wherein the computer instructions are used for causing a computer to execute the substance detection method involved in any method embodiments of the present application.

### Advantageous Effects

Compared with the prior art, the embodiments of the present application have the advantages of adding the detachable attribute in the corresponding items of the substance stored in the database to mark whether the substance is a mixture, therefore, whether the to-be-detected substance is the mixture can be queried from the database, and after the to-be-detected substance is determined as a mixture, the mixture component information of the to-be-detected substance is further provided for the user, thereby greatly improving the user experience and satisfying the actual needs of the user.

### BRIEF DESCRIPTION OF THE DRAWINGS

One or more embodiments are exemplified by figures in corresponding drawings, these exemplary descriptions do not constitute limitations of the embodiments, elements having the same reference signs in the drawings are represented as similar elements, and unless otherwise stated, the figures in the drawings do not constitute proportional limits.

FIG. 1 is a flow diagram of a substance detection method in a first embodiment of the present application;

FIG. 2 is a flow diagram of a substance detection method in a second embodiment of the present application;

FIG. 3 is a flow diagram of a substance detection method in a third embodiment of the present application;

FIG. 4 is a schematic block diagram of a substance detection apparatus in a fourth embodiment of the present application;

FIG. 5 is a schematic block diagram of a substance detection apparatus in a fifth embodiment of the present application;

FIG. 6 is a schematic block diagram of a substance detection apparatus in a sixth embodiment of the present application;

FIG. 7 is a structure example diagram of an electronic device in a seventh embodiment of the present application.

### EMBODIMENTS OF THE INVENTION

In order that the objects, the technical solutions and the advantages of the present application are clearer, a part of embodiments of the present application will be further described in detail below in combination with the drawings and embodiments. It should be understood that the specific embodiments described herein are merely used for explaining the present application rather than limiting the present application.

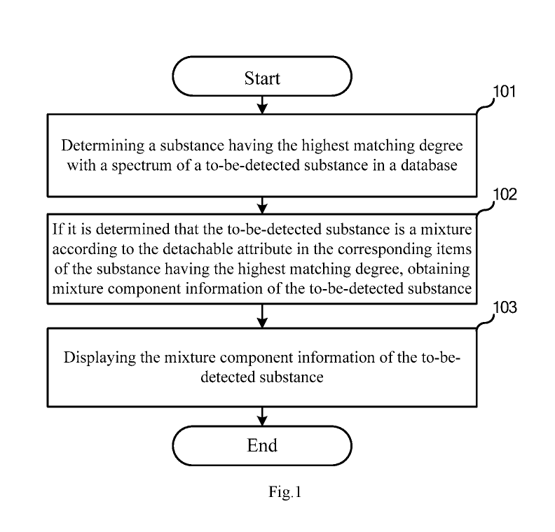

A first embodiment of the present application relates to a substance detection method, and an executive body of the substance detection method may be any electronic device capable of accessing a database, such as an optical detection device (a spectrometer or the like) capable of accessing the database, or a database server itself that installs the database, or other servers capable of accessing the database server, or the like. The specific process of the substance detection method is shown in FIG. 1 and includes the following steps:

In step 101, a substance having the highest matching degree with a spectrum of a to-be-detected substance in a database is determined.

Specifically, in the present embodiment, corresponding items of the substance in the database at least include a detachable attribute for marking whether the substance is a mixture, the specific form of the detachable attribute may be a letter identifier or a digital identifier or the like, for example, if the substance is a mixture, then the detachable attribute in the corresponding items of the substance is marked with a letter Y, or otherwise, the detachable attribute in the corresponding items of the substance is marked with a letter N; or, if the substance is a mixture, the detachable attribute in the corresponding items of the substance is marked with a number 1, or otherwise, the detachable attribute in the corresponding items of the substance is marked with a number 2. The user may set the specific expression form of the detachable attribute according to actual needs, which is not specifically limited in the present embodiment.

In specific implementation, there are many ways to determine the substance having the highest matching degree with the spectrum of the to-be-detected substance in the database. For example, the spectrum of the to-be-detected substance may be directly compared with the spectra of known substances in the database to obtain the known substance having the highest spectrum similarity to serve as the substance having the highest matching degree with the spectrum of the to-be-detected substance. As another example, the features of the spectrum of the to-be-detected substance are extracted, the extracted features are matched with the features of the spectra of the known substances stored in the database to determine the known substance having the highest matching degree, and the known substance having the highest matching degree is obtained to serve as the substance having the highest matching degree with the spectrum of the to-be-detected substance. Of course, this is only an example, other matching methods may also be used in the application, and the employed specific matching method is not limited in the present application.

In step 102, if it is determined that the to-be-detected substance is a mixture according to the detachable attribute in the corresponding items of the substance having the highest matching degree, mixture component information of the to-be-detected substance is obtained.

Specifically, the mixture component information may be only the name of each component of the mixture, and may also include the name of each component of the mixture and the proportion of each component in the mixture at the same time.

Using New Contec as the to-be-detected substance for an example, after the substance having the highest matching degree with the spectrum of the New Contec in the database is determined, it may be determined that the to-be-detected substance, the New Contec, is a mixture according to the letter mark Y of the detachable attribute in the corresponding items of the substance having the highest matching degree. After it is determined that the to-be-detected substance is the mixture, the name of each component of the mixture, the New Contec, and the proportion of each component in the mixture are further obtained, for example, the obtained mixture component information of the New Contec includes: acetaminophen 50%, dextromethorphan hydrobromide 2%, pseudoephedrine hydrochloride 4%, chlorpheniramine maleate 1%, starch 35%, magnesium stearate 8% and so on.

In step 103, the mixture component information of the to-be-detected substance is displayed.

Specifically, different mixture component information display manners may be provided according to different setting manners, for example, it may be set to display only the name of each component of the mixture, or, it may be set to simultaneously display the name of each component of the mixture and the proportion of each component in the mixture.

For example, using the New Contec as an example, if it is set to display only the name of each component of the mixture, then the display results are acetaminophen, dextromethorphan hydrobromide, pseudoephedrine hydrochloride, chlorpheniramine maleate, starch, magnesium stearate and so on; and if it is set to simultaneously display the name of each component of the mixture and the proportion of each component in the mixture, then the display results are acetaminophen 50%, dextromethorphan hydrobromide 2%, pseudoephedrine hydrochloride 4%, chlorpheniramine maleate 1%, starch 35%, magnesium stearate 8% and so on.

Compared with the prior art, the substance detection method provided by the present embodiment has the advantages of adding the detachable attribute in the corresponding items of the substance stored in the database to mark whether the substance is the mixture, therefore, whether the to-be-detected substance is the mixture can be queried from the database, and after the to-be-detected substance is determines as the mixture, the mixture component information of the to-be-detected substance is further provided for the user, thereby greatly improving the user experience and satisfying the actual needs of the user.

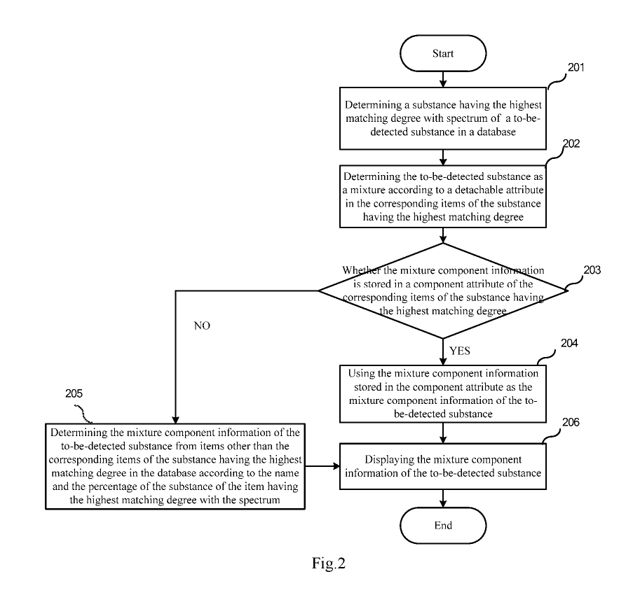

A second embodiment of the present application relates to a substance detection method, which represents a further improvement on the basis of the first embodiment of the present application, and the specific improvement lies in that: the manner of obtaining the mixture component information of the to-be-detected substance is described in detail. The flow of the substance detection method in the present embodiment is as shown in FIG. 2.

Specifically, the present embodiment includes step 201 to step 206, wherein the step 201 is substantially the same as the step 101 in the first embodiment, and the step 206 is substantially the same as the step 103 in the first embodiment, therefore are not described repeatedly herein, the difference is mainly described below, and for technical details that are not described in detail in the present embodiment, reference may be made to the substance detection method provided in the first embodiment, and thus this is not described herein again.

After the step 201, the step 202 is executed.

In the step 202, the to-be-detected substance is determined as the mixture according to the detachable attribute in the corresponding items of the substance having the highest matching degree.

In the step 203, whether the mixture component information is stored in component attributes of the corresponding items of the substance having the highest matching degree is identified, if so, the step 204 is executed, otherwise the step 205 is executed.

Specifically, the items further include a component attribute for storing the mixture component information, after it is determined that the to-be-detected substance is the mixture, the component attribute of the corresponding items of the substance having the highest matching degree in the database may be further queried, and whether the mixture component information is stored in the component attribute of the corresponding items of the substance having the highest matching degree is identified by query.

For example, after it is determined that the to-be-detected substance is the mixture, if it is obtained that the data stored in the component attribute are empty by query, or are a mark (such as “NA”) for unsaved mixture component information, then it is determined that the mixture component information is unsaved; or, otherwise, it is determined that the mixture component information is stored in the component attribute.

In the specific implementation, the items further include: one or more of a substance identification (ID) attribute for marking a code serial number of the substance in the database, a substance name attribute for marking a category name of the substance, a substance spectrum attribute for marking spectrum data information of the substance, a feature attribute for marking physical and functional feature information of the substance, a danger attribute for marking the danger level information of the substance, and the like. In practical application, the user may autonomously set the specific categories contained in the item stored in the database according to the query needs. In the present embodiment, it is used as an example that the items stored in the database include the seven attributes listed above, which are respectively: the substance identification (ID) attribute, the substance name attribute, the substance spectrum attribute, the feature attribute, the danger attribute, the detachable attribute and the component attribute. For example, the specific storage forms of the items in the database are shown in Table 1.

TABLE 1
Items

| Substance | Substance | Substance | | | | |
|---|---|---|---|---|---|---|
| ID | name | spectrum | Feature | Danger | Detachable | Component |
| 00001 | Potassium | spectrum | White particles, | Low | N | NA |
| | nitrate | data | soluble | | | |
| | | | in water . . . | | | |
| 00002 | New Contec | spectrum | Cold cure, | No | Y | Acetaminophen, |
| | | data | compound | | | dextromethorphan |
| | | | preparation . . . | | | hydrobromide, |
| | | | | | | pseudoephedrine |
| | | | | | | hydrochloride, |
| | | | | | | chlorpheniramine |
| | | | | | | maleate, starch, and |
| | | | | | | magnesium stearate |
| . . . | . . . | . . . | . . . | . . . | . . . | . . . |
| 28888 | TNT | spectrum | Strong | High | N | NA |
| | (Trinitrotoluene) | data | explosive, | | | |
| | | | the chemical | | | |
| | | | formula is . . . | | | |

In the step 204, the mixture component information stored in the component attribute is used as the mixture component information of the to-be-detected substance.

In the step 205, the mixture component information of the to-be-detected substance is determined from the items excluding the corresponding items of the substance having the highest matching degree in the database according to the name and the percentage of the substance of the item having the highest matching degree with the spectrum.

It should be noted that when it is identified that the mixture component information is not stored in the component attribute of the corresponding items of the substance having the highest matching degree according to the query result of the database, the spectrum of the to-be-detected substance needs to be matched with the spectra of the known substances in the database again to indirectly obtain the mixture component information of the to-be-detected substance.

For example, if it is determined by matching that the substance having the highest degree in the database is the New Contec, but the component information of the New Contec is not stored in the component attribute of the corresponding items in the database, matching is performed with the substances other than the New Contec in the database, the obtained item having the highest matching degree may be: acetaminophen 50%, dextromethorphan hydrobromide 2%, pseudoephedrine hydrochloride 4%, chlorpheniramine maleate 1%, starch 35%, magnesium stearate 8% and so on. The item having the highest matching degree includes the names of the components constituting the New Contec and the percentage of each component in the New Contec. The obtained item having the highest matching degree is determined as the mixture component information of the New Contec.

It should be noted that the method of re-matching the spectrum of the to-be-detected substance with the spectra of the known substances in the database may be any one of the existing matching methods, and may also be improved methods of the existing matching methods and the like, and how to match is not the focus of the present application.

Compared with the prior art, the substance detection method provided by the present embodiment has the advantages of adding the detachable attribute in the corresponding items of the substance stored in the database to mark whether the substance is the mixture, therefore, whether the to-be-detected substance is the mixture can be queried from the database, and after the to-be-detected substance is determines as the mixture, the mixture component information of the to-be-detected substance is further provided for the user, thereby greatly improving the user experience and satisfying the actual needs of the user. Moreover, the component attribute is added to the corresponding items of the substance in the database, and the mixture component information that has been obtained by analysis is stored in the corresponding component attribute, so that the mixture component information can be directly obtained from the component attribute, and the acquisition efficiency of the mixture component information is improved.

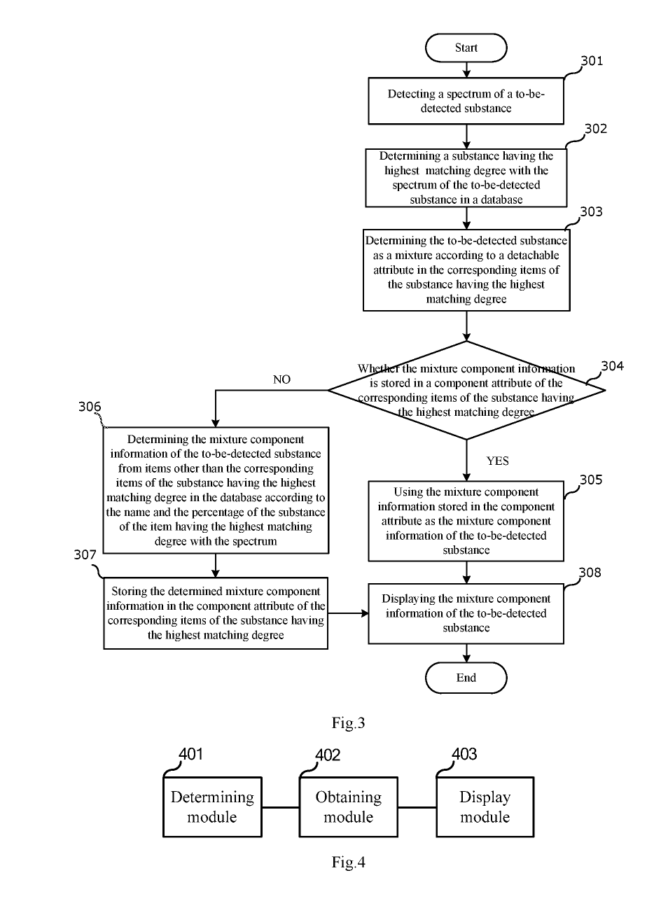

A third embodiment of the present application relates to a substance detection method, the present embodiment represents a further improvement on the basis of the second embodiment, and the specific improvement is as follows: if it is determined that the mixture component information is not stored in the items of the substance having the highest matching degree obtained by the primary matching, secondary matching is performed, that is, matching is performed with the items other than the items having the highest matching degree obtained by the primary matching in the database, the mixture component information of the to-be-detected substance is determined according to the matching result, and the mixture component information determined by the secondary matching is stored in the component attribute of the items having the highest matching degree obtained by the primary matching, and the specific flow is as shown in FIG. 3.

Specifically, in the present embodiment, the method includes step 301 to step 308, wherein the step 302 to the step 304 are substantially the same as the step 201 to the step 203 in the second embodiment, the step 305 is the substantially same as the step 204 in the second embodiment, the step 308 is substantially the same as the step 206 in the second embodiment, and the step 306 is substantially the same as the step 205 in the second embodiment, therefore are not described repeatedly herein, the difference is mainly described below, and for technical details that are not described in detail in the present embodiment, reference may be made to the substance detection method provided in the first embodiment, and thus this is not described herein again.

In step 301, the spectrum of the to-be-detected substance is detected.

In practical application, the spectrum of the to-be-detected substance may be collected by a spectrometer to obtain the spectrum of the to-be-detected substance.

The step 302 to the step 303 are executed after the step 301.

In the step 304, whether the mixture component information is stored in the component attribute of the corresponding items of the substance having the highest matching degree is identified, if so, the step 305 is executed, or otherwise the step 306 is executed.

In the step 305, the mixture component information stored in the component attribute is used as the mixture component information of the to-be-detected substance.

In the step 306, the mixture component information of the to-be-detected substance is determined from the items other than the corresponding items of the substance having the highest matching degree in the database according to the name and the percentage of the substance of the item having the highest matching degree with the spectrum.

In the step 307, the determined mixture component information is stored in the component attribute of the corresponding items of the substance having the highest matching degree.

Specifically, since the detected mixture component information is stored in the component attribute of the corresponding items of the substance, the mixture component information stored in the component attribute may be directly obtained next time, therefore, it is not necessary to perform the component detection every time, thereby avoiding the problem of low efficiency caused by the component detection that is performed every time.

A fourth embodiment of the present application relates to a substance detection apparatus, the specific structure of which is shown in FIG. 4.

As shown in FIG. 4, the substance detection apparatus includes a determining module 401, an obtaining module 402 and a display module 403.

The determining module 401 is configured to determine a substance having the highest matching degree with a spectrum of a to-be-detected substance in a database, wherein corresponding items of the substance in the database at least include a detachable attribute for marking whether the substance is a mixture.

The obtaining module 402 is configured to, if it is determined that the to-be-detected substance is a mixture according to the detachable attribute in the corresponding items of the substance having the highest matching degree, obtain mixture component information of the to-be-detected substance.

The display module 403 is configured to display the mixture component information of the to-be-detected substance.

It is not difficult to find that the present embodiment is an apparatus embodiment corresponding to the first embodiment, and the present embodiment may be implemented in cooperation with the first embodiment. Related technical details mentioned in the first embodiment are still effective in the present embodiment, and are not described herein again in order to reduce the repetition. Accordingly, the related technical details mentioned in the present embodiment may also be applied to the first embodiment.

A fifth embodiment of the present application relates to a substance detection apparatus, the present embodiment is substantially the same as the fourth embodiment, and the specific structure is as shown in FIG. 5. The main improvement is that the structure of the obtaining module 402 in the fourth embodiment is specifically described in the fifth embodiment. The obtaining module 402 specifically includes: a mixture determining submodule 4021, an identifying submodule 4022, a first obtaining submodule 4023 and a second obtaining submodule.

The mixture determining submodule 4021 is configured to determine the to-be-detected substance as the mixture according to the detachable attribute in the corresponding items of the substance having the highest matching degree.

The identifying submodule 4022 is configured to identify whether mixture component information is stored in the component attribute of the corresponding items of the substance having the highest matching degree.

The first obtaining submodule 4023 is configured to, when it is determined that the mixture component information is stored in the component attribute of the corresponding items of the substance having the highest matching degree through the identifying submodule 4022, use the mixture component information stored in the component attribute as the mixture component information of the to-be-detected substance.

The second obtaining submodule 4024 is configured to, when it is determined that the mixture component information is not stored in the component attribute of the corresponding items of the substance having the highest matching degree through the identifying submodule 4022, determine the mixture component information of the to-be-detected substance from the items other than the corresponding items of the substance having the highest matching degree in the database according to the name and the percentage of the substance of the item having the highest matching degree with the spectrum.

It is not difficult to find that the present embodiment is an apparatus embodiment corresponding to the second embodiment, and the present embodiment may be implemented in cooperation with the second embodiment. Related technical details mentioned in the second embodiment are still effective in the present embodiment, and are not described herein again in order to reduce the repetition. Accordingly, the related technical details mentioned in the present embodiment may also be applied to the second embodiment.

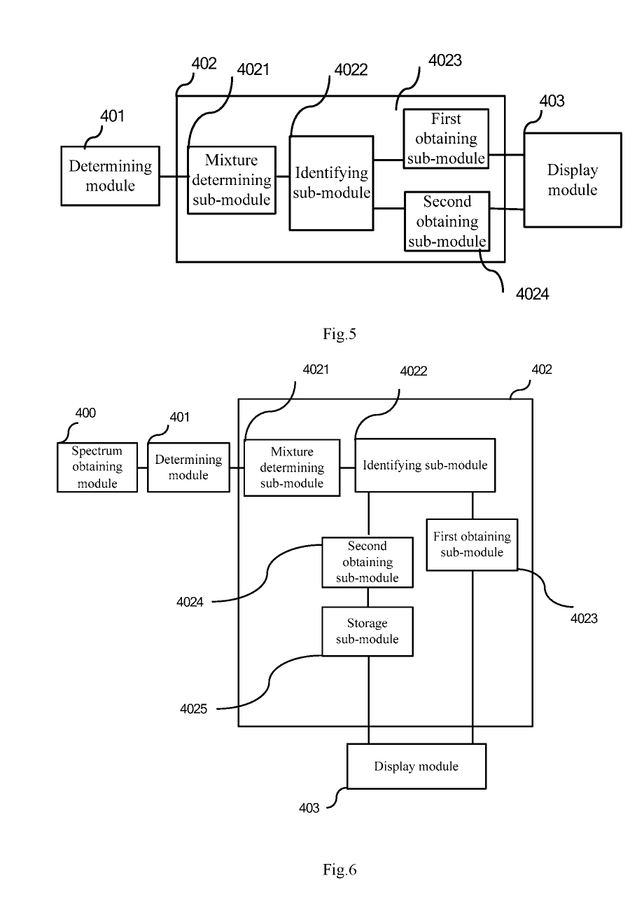

A sixth embodiment of the present application relates to a substance detection apparatus, the present embodiment is substantially the same as the fifth embodiment, and the specific structure is as shown in FIG. 6. The main improvement is that a spectrum obtaining module 400 is added in the sixth embodiment on the basis of the fifth embodiment; in addition, a storage submodule 4025 is newly added in the obtaining module 402 in the fifth embodiment.

The spectrum obtaining module 400 is configured to detect a spectrum of the to-be-detected substance.

The storage submodule 4025 is configured to store the determined mixture component information in the component attribute of the substance attribute having the highest matching degree.

It is not difficult to find that the present embodiment is an apparatus embodiment corresponding to the third embodiment, and the present embodiment may be implemented in cooperation with the third embodiment. Related technical details mentioned in the third embodiment are still effective in the present embodiment, and are not described herein again in order to reduce the repetition. Accordingly, the related technical details mentioned in the present embodiment may also be applied to the third embodiment.

The apparatus embodiments described above are merely illustrative and do not limit the protection scope of the present application. In practical application, those skilled in the art may select some or all of the modules according to actual needs to achieve the purpose of the solution in the present embodiment, which is not limited herein.

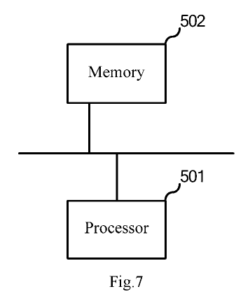

A seventh embodiment of the present application relates to an electronic device, and the specific structure is as shown in FIG. 7. The electronic device includes: at least one processor 501; and a memory 502 in communication connection with the at least one processor 501. The memory 502 stores instructions executable by the at least one processor 501, and the instructions are executed by the at least one processor 501 to enable the at least one processor 501 to execute the substance detection method.

In the present embodiment, the processor 501 is exemplified by a central processing unit (CPU), and the memory 502 is exemplified by a random access memory (RAM). The processor 501 and the memory 502 may be connected by a bus or in other manner, and bus connection is used as an example in FIG. 7. The memory 502 serving as a nonvolatile computer readable storage medium may be used for storing nonvolatile software programs, nonvolatile computer-executable programs and modules, for example, a program for implementing an detection method in the present embodiment of the present application is stored in the memory 502. The processor 501 executes various function applications and data processing of the device, that is, implements the above substance detection method, by running the non-volatile software programs, instructions and modules stored in the memory 502.

The memory 502 may include a program storage area and a data storage area, wherein the program storage area may store an operating system, and an application program required for at least one function; and the data storage area may store option lists, and the like. Further, the memory may include a high-speed random access memory and may also include a nonvolatile memory, such as at least one magnetic disk storage device, a flash memory or other nonvolatile solid state storage devices. In some embodiments, the memory 502 optionally includes memories that are remotely located relative to the processor 501, and these remote memories may be connected to an external device through a network. Examples of the above network include, but not limited to, the Internet, an intranet, a local area network, a mobile communication network, and combinations thereof.

One or more program modules are stored in the memory 502 and execute the substance detection method of any of the above method embodiments, when being executed by one or more processors 501.

The above-mentioned product may implement the method provided by the embodiment of the present application, and has corresponding functional modules and advantageous effects of executing the method, and for technical details that are not described in detail in the present embodiment, reference may be made to the method provided by the embodiment of the present application.

An eighth embodiment of the present application relates to a computer readable storage medium storing a computer instruction, and the computer instruction can execute the substance detection method involved in any of the method embodiments of the present application.

Those skilled in the art may understand that all or a part of the steps for implementing the method in the above embodiments may be completed by a program instructing related hardware, and the program is stored in a storage medium, including a plurality of instructions for causing a device (may be a single chip microcomputer, a chip or the like) or a processor (processor) to execute all or a part of steps of the method in various embodiments of the present application. The foregoing storage medium includes all kinds of media capable of storing program codes, such as a USB flash disk, a mobile hard disk, a read-only memory (ROM), a random access memory (RAM), a magnetic disk, or an optical disk, or the like.

Those of ordinary skill in the art may understand that the above embodiments are specific embodiments for implementing the present application, but in practical application, various changes may be made in the forms and details without departing from the spirit and scope of the present application.

1. A substance detection method, comprising:
determining a substance having the highest matching degree with a spectrum of a to-be-detected substance in a database, wherein corresponding items of the substance in the database at least comprise a detachable attribute for marking whether the substance is a mixture;
if it is determined that the to-be-detected substance is a mixture according to the detachable attribute in the corresponding items of the substance having the highest matching degree, obtaining mixture component information of the to-be-detected substance; and
displaying the mixture component information of the to-be-detected substance.

2. The substance detection method according to claim 1, wherein the items further comprise a component attribute for storing the mixture component information;
the obtaining mixture component information of the to-be-detected substance comprises:
identifying whether the mixture component information is stored in the component attribute of the corresponding items of the substance having the highest matching degree;
if yes, using the mixture component information stored in the component attribute as the mixture component information of the to-be-detected substance;
otherwise, determining the mixture component information of the to-be-detected substance from items other than the corresponding items of the substance having the highest matching degree in the database according to the name and the percentage of the substance of the item having the highest matching degree with the spectrum.

3. The substance detection method according to claim 2, wherein after determining the mixture component information of the to-be-detected substance according to the name and the percentage of the substance of the item having the highest matching degree with the spectrum, the substance detection method further comprises:
storing the determined mixture component information in the component attribute of the corresponding items of the substance having the highest matching degree.

4. The substance detection method according to claim 1, wherein the mixture component information comprises: a name of each component and the proportion of each component in the mixture.

5. The substance detection method according to claim 1, wherein before determining a substance having the highest matching degree with the spectrum of a to-be-detected substance in a database, the substance detection method further comprises:
detecting the spectrum of the to-be-detected substance.

6. An electronic device, comprising:
at least one processor; and
a memory in communication connection with the at least one processor; wherein
the memory stores instructions executable by the at least one processor, and the instructions are executed by the at least one processor to enable the at least one processor to execute the substance detection method according to claim 1.

7. A computer readable storage medium, storing computer instructions, wherein the computer instructions are used for causing a computer to execute the substance detection method according to claim 1.
